(19) United States
(12) Patent Application Publication
(10) Pub. No.: US 2009/0152966 A1
(43) Pub. Date: Jun. 18, 2009

(54) BEARING SEALS

(75) Inventors: Eberhard Bock, Monlenbach (DE); Martin Gramlich, Hirschberg (DE)

Correspondence Address: HARNESS, DICKEY & PIERCE, P.L.C., P.O. BOX 828, BLOOMFIELD HILLS, MI, 48303, US

(73) Assignee: CARL FREUDENBERG KG, Weinheim (DE)

(21) Appl. No.: 12/248,955

(22) Filed: Oct. 10, 2008

(30) Foreign Application Priority Data
Oct. 11, 2007 (EP) 07019974.0

(51) Int. Cl. H02K 5/167

(52) U.S. Cl. 310/90

(57) ABSTRACT

Bearing arrangement (1) for supporting a shaft (2) in a housing (3), wherein there is formed in the housing (3) at least one cupped bearing surface (4) on which the shaft (2) can be positioned, wherein a gap (5) is formed between the bearing surface (4) and the shaft (2), and wherein at least one throttling element (6) is provided in the gap (5).

### TECHNICAL FIELD

The invention concerns a bearing arrangement for supporting a shaft in a housing.

### PRIOR ART

Shafts of internal combustion engines are generally supported in plain bearings. A plain bearing includes a bearing surface that at least partially encloses the shaft to be supported, there being a gap between the bearing surface and shaft in which a lubricant is located. These lubricants can reach the gap through bores, grooves, or other recesses in the bearing surface or even in the shaft. The bearing arrangement's gap is subjected to variations resulting from different thermal expansion coefficients of the housing and shaft. An excessively large gap here results in an undesirably large outflow of lubricant from the bearing arrangement, which can lead to break-off of the lubricating film in the gap, and thus to premature wear of the bearing arrangement. A problem of this nature results in particular when light alloy is used in the construction of the housing, since the thermal expansion coefficient of light alloy differs from the thermal expansion coefficient of steel, the most commonly used material for shafts. The support of shafts that are not subjected to loads as severe as in the case of the crankshaft should be accomplished as simply as possible and using a small number of parts.

### DESCRIPTION OF THE INVENTION

The object of the invention is to provide a bearing arrangement for supporting a shaft in a housing, which is simple and economical to manufacture.

This object is attained with the features in claim 1. The dependent claims refer to advantageous embodiments.

In order to attain the object, a bearing arrangement for supporting a shaft in a housing is proposed, wherein there is formed in the housing at least one cupped bearing surface on which a shaft can be positioned, wherein a gap is formed between the bearing surface and the shaft, and wherein at least one throttling element is provided in the gap. According to the invention, the bearing surface is integrated directly in the housing. To this end, a bearing block is formed in the housing and the surfaces facing the shaft are machined such that they form the bearing surfaces. The bearing block with the bearing surface is thus designed as a single piece with the housing and from the same material. According to the invention, bearing shells are not used, resulting in a bearing arrangement that has a low parts count and is economical to manufacture. This bearing arrangement is suitable in particular for supporting shafts that are not as severely mechanically stressed as the crankshaft of an internal combustion engine. Such shafts include, for example, the camshaft or balance shaft of an internal combustion engine or various shafts of a transmission. Since the housing, which forms a part of the bearing arrangement here, is frequently made of light alloy, while the shafts are preferably made of a steel alloy, a throttling element is provided in the gap between the bearing surface and the shaft. This limits the flow of lubricant and keeps the lubricant pressure in the bearing arrangement from dropping at high temperatures when the gap size has increased, thus preventing break-off of the lubricating film located in the gap.

It is possible to provide two throttling elements per bearing surface, each of which is associated with one edge of the bearing surface. In this way, the gap formed between the bearing surface and the shaft is delimited by throttling elements on both sides.

In the bearing surface, at least one recess may be provided, in which the throttling element is arranged. The throttling element is contained in the recess and is thus fixed in place. The recess can be designed such that the throttling element is supported therein with clearance, and the lubricant preferably passes through the gap between the recess and the throttling element. This embodiment permits expansion of the throttling element in the radial direction. The recess preferably takes the form of a groove that extends at least part way around in the bearing surface.

The throttling element can be designed to be at least a segment of a circle. Bearing arrangements frequently have a contouring of the bearing surface on only one half circle. When this is the case, the bearing surface is contoured that faces toward the primary direction of loading, and thus is not as heavily loaded as the other bearing surface located on the side facing away from the primary direction of loading. Contouring here is understood to mean the arranging of recesses and devices for supplying the bearing arrangement with lubricant. Under loading, a larger gap is produced on the side of the bearing surface located opposite the primary loading. Consequently, a throttling element that delimits the lubricant flow is preferably located here. To this end, the throttling element can preferably be semicircular in design.

The throttling element can be designed in the shape of a ring. Such throttling elements enclose the shaft entirely and are especially advantageous for shafts with alternating loading directions.

The throttling element can be designed as a ring with a rectangular cross-section. Rings with rectangular cross-sections are simple and economical to manufacture.

The throttling element can be arranged on the shaft so as to be rotatable relative to the recesses. To this end, the throttling element preferably has a slot so that it can be expanded for installation on the shaft. After installation, the throttling element is rotationally fixed on the shaft and floats in the recess. The lubricant flow takes place in the resulting gap between the recess and throttling element. In this embodiment, it is advantageous that the throttling element can move and expand in the radial direction, and, depending on the width of the recess, in the axial direction as well. The gap width in the axial direction, which is to say between side walls of the recess and throttling element, is determined by the lubricant pressure.

The throttling element can have at least one protrusion and/or indentation on the outer and/or inner circumferential side. The basic shape of the throttling element here is a ring with a rectangular cross-section, designed as a full or partial circle, for example a semi-circle. Advantageous embodiments of the throttling element have an indentation or protrusion approximately centered on the outer circumferential side. The indentation or protrusion can be circular in shape. In another advantageous embodiment, the throttling element has an indentation on the outer and inner circumferential sides. As a result of this profiling, the material adjacent to the indentation, or the protrusion itself, can deflect in the radial direction into the adjacent free areas even under compressive loading, for example resulting from expansion of the throttling element in the limited installation space, thus providing stress relief. Preferably, a material is selected that deforms plastically under the effects of pressure and temperature. It is then possible through the material choice and shaping of the throttling element for the optimal lubricant flow to be established over the long term following a short break-in time. Possible materials for the throttling element preferably include polymers, in particular also polytetrafluoroethylene (PTFE compounds), polyetheretherketone (PEEK), polyamide imide (PAI) and polyimide. This advantageous effect of the above-described throttling element is not limited to the bearing arrangement described here, but instead, such throttling elements can advantageously be used in all conceivable plain bearings equipped with throttling elements.

The throttling element can have associated with it a spring element, which presses the throttling element against the shaft. To this end, the spring element can engage the throttling element directly and preferably on its outer circumferential side. In other embodiments the spring element may also engage the throttling element indirectly. The spring element effects a uniform pressure of the throttling element, regardless of the hydrodynamic and static lubricant pressure. Thus, the throttling element always remains against the shaft, even when the shaft is starting up, for example. Moreover, the throttling element can be decoupled from the influence of hydrodynamic pressure. The decoupling can be accomplished through structural adaptation or a separate component. The decoupling can take place such that the hydrodynamic lubricant pressure acts only on the edge.

A device for supplying lubricant can be provided. The device can take the form of a bore that terminates in the bearing surface or also in the shaft, preferably between two throttling elements. In addition to the bore, it is also possible to provide a groove in which the lubricant supplied through the bore is distributed in the intermediate space between the throttling elements, the bearing surface, and the shaft.

Use of the bearing arrangement according to one of the preceding claims for supporting cam shafts, balance shafts, selector shafts, or transmission shafts [sic]. The above-described bearing arrangement is especially suitable for supporting the above-described shafts, since they are not subjected to the same types of loads as a crankshaft. Consequently, they should also be of simpler design for reasons of cost.

### BRIEF DESCRIPTION OF THE DRAWINGS

Some example embodiments of the inventive bearing arrangement are explained in detail on the basis of the appended figures. These drawings show schematically:

FIG. 1 an inventive bearing arrangement;

FIG. 2 some example embodiments of throttling elements.

### IMPLEMENTATION OF THE INVENTION

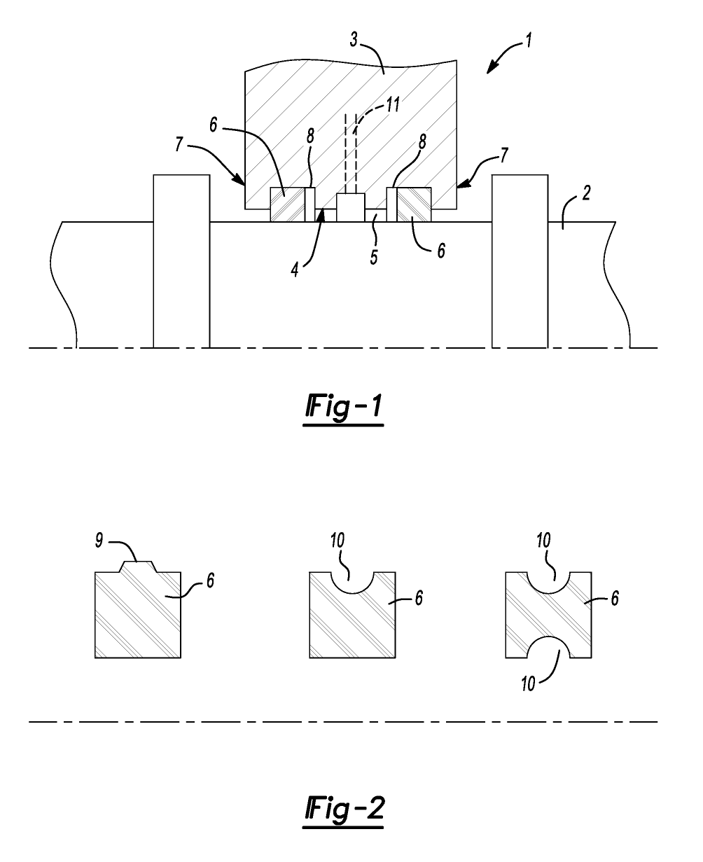

FIG. 1 shows a bearing arrangement 1 for supporting a shaft 2 in a housing 3. Formed directly in the housing 3 is a cupped bearing surface 4, on which the shaft 2 is rotatably mounted. During operation, a gap 5 forms between the bearing surface 4 and shaft 2 due to the hydrodynamic pressure of the lubricant, and under some circumstances, also due to additional influences, for example spring forces. In order to delimit the lubricant flow, two throttling elements 6 are provided in the gap 5, each of which elements is associated with an edge 7 of the bearing surface 4. The throttling elements 6 are guided and fixed in place in recesses 8 provided in the bearing surface 4. In this embodiment, the throttling elements 6 are designed in the form of semicircular rings with a rectangular cross-section. In another embodiment, the throttling elements 6 are designed and arranged on the shaft 2 so as to rotate relative to the recesses 8. Provided in the gap 5 between the throttling elements 6 is a device 11 for supplying lubricant. This bearing arrangement 1 is especially well suited for supporting cam shafts, balance shafts, selector shafts, or transmission shafts.

FIG. 2 shows different embodiments of a throttling element which may also be used in other plain bearing arrangements in addition to the bearing arrangement 1 described above. The throttling element 6 is designed in the basic shape of a ring with a rectangular cross-section, wherein the throttling element may be circular, or may also describe only a partial circle, for example a semi-circle. The throttling element is made of a polymer material, for example PTFE, PEEK, or PAI. In the first embodiment, the throttling element 6 has a trapezoidal protrusion 9 on the outer circumferential side. In the second embodiment, the throttling element 6 has a semicircular indentation 10 on the outer circumferential side, and in the third embodiment, the throttling element 6 has a semicircular indentation 10 on both the outer and inner circumferential sides.

1. A bearing arrangement for supporting a shaft comprising:
a housing;
at least one cupped bearing surface formed in the housing adjacent to which the shaft is positioned;
a gap formed between the bearing surface and the shaft; and
at least one throttling element provided in the gap.

2. A bearing arrangement according to claim 1, wherein two throttling elements are provided in the gap, each of which is associated with an edge of the bearing surface.

3. A bearing arrangement according to claim 1, wherein at least one recess, in which the throttling element is arranged, is provided in the bearing surface.

4. A bearing arrangement according to claim 1, wherein the throttling element is designed to be at least a segment of a circle.

5. A bearing arrangement according to claim 1, wherein the throttling element is designed in the shape of a ring.

6. A bearing arrangement according to claim 1, wherein the throttling element is designed in the shape of a ring with a rectangular cross-section.

7. A bearing arrangement according to claim 3, wherein the throttling element is arranged on the shaft so as to be rotatable relative to the recess.

8. A bearing arrangement according to claim 1, wherein the throttling element (6) has at least one protrusion or indentation on an outer and/or an inner circumferential side.

9. A bearing arrangement according to claim 1, wherein, is a spring element presses the throttling element against the shaft.

10. A bearing arrangement according to claim 1, further comprising a device for supplying lubricant formed in the housing.

11. (canceled)
